(19) United States
(12) Patent Application Publication
(10) Pub. No.: US 2017/0187980 A1
(43) Pub. Date: Jun. 29, 2017

(54) CURVED TELEVISION AND FIXED BASE THEREOF

(71) Applicant: SHENZHEN CHINA STAR OPTOELECTRONICS TECHNOLOGY CO., LTD., Shenzhen, Guangdong (CN)

(72) Inventor: Chengling LV, Shenzhen, Guangdong (CN)

(21) Appl. No.: 15/021,705

(22) PCT Filed: Feb. 25, 2016
(86) PCT No.: PCT/CN2016/074498

§ 371 Date: Mar. 14, 2016

(30) Foreign Application Priority Data
Dec. 23, 2015 (CN) 201510974334.3

(51) Int. Cl. H04N 5/655

(52) U.S. Cl. CPC H04N 5/655

(57) ABSTRACT

A curved television and a fixed base are described. The fixed base has a bottom wall and two side walls. The bottom wall has a curvature identical to that of a curved television. The two side walls are extended upward from two opposite sides of the bottom wall respectively. The two side walls and the bottom wall commonly define a groove so as to accommodate a base of the curved television, such that an effect of changing a position of the curved television according to a user's requirements can be achieved.

### FIELD OF THE INVENTION

The present invention relates to a fixed base, and more particularly to a fixed base of a curved television.

### BACKGROUND OF THE INVENTION

In recent years, due to advances in electronic products, curved or arcuate structures have begun to be used in more and more products, such as curved televisions. In order to improve the viewing quality, a user generally needs to be at a center of curvature of the curved television. Because a base of the curved television is fixed, not only are the viewing positions and viewing angles limited, but also the using convenience of moving and adjusting the curved television is not improved.

As a result, it is necessary to provide a fixed base of a curved television to solve the problems existing in the conventional technologies.

### SUMMARY OF THE INVENTION

In view of this, the present invention provides a curved television and a fixed base thereof, so as to solve the problems that the user's viewing positions and viewing angles are limited by the existing curved television, and the using convenience of moving and adjusting the curved television is not improved, and so on.

To achieve the above object, an embodiment of the present invention provides a fixed base of a curved television, wherein the fixed base of the curved television comprises: a bottom wall and two side walls. The bottom wall has a curvature identical to that of a curved television. The two side walls are extended upward from two opposite sides of the bottom wall respectively, wherein the two side walls and the bottom wall commonly define a groove so as to movably accommodate a base of the curved television, wherein the bottom wall further comprises two slide channels, and the base has at least two pulleys respectively corresponding to each of the slide channels; and the base is loosely fitted with and accommodated inside the groove.

In one embodiment of the present invention, a length of the bottom wall is identical to that of the base.

In one embodiment of the present invention, a length of the bottom wall is greater than that of the base.

In one embodiment of the present invention, the groove is a flat and straight groove, and the base is a flat and straight rib complementary to the flat and straight groove.

In one embodiment of the present invention, the groove is a dovetail-shaped groove, and the base is a wedge-shaped rib complementary to the dovetail-shaped groove.

To achieve the above object, another embodiment of the present invention provides a fixed base of a curved television, wherein the fixed base of the curved television comprises: a bottom wall and two side walls. The bottom wall has a curvature identical to that of a curved television. The two side walls are extended upward from two opposite sides of the bottom wall respectively, wherein the two side walls and the bottom wall commonly define a groove so as to movably accommodate a base of the curved television.

In one embodiment of the present invention, a length of the bottom wall is identical to that of the base.

In one embodiment of the present invention, a length of the bottom wall is greater than that of the base.

In one embodiment of the present invention, the groove is a flat and straight groove and the base is a flat and straight rib complementary to the flat and straight groove.

In one embodiment of the present invention, the groove is a dovetail-shaped groove, and the base is a wedge-shaped rib complementary to the dovetail-shaped groove.

In one embodiment of the present invention, the bottom wall further comprises two slide channels, and the base has at least two pulleys respectively corresponding to each of the slide channels.

In one embodiment of the present invention, the base is loosely fitted with and accommodated inside the groove.

Furthermore, an embodiment of the present invention provides a curved television, wherein the curved television comprises: a base and a fixed base. The fixed base has: a bottom wall with a curvature identical to that of the curved television; and two side walls extended upward from two opposite sides of the bottom wall respectively, wherein the two side walls and the bottom wall commonly define a groove so as to movably accommodate the base of the curved television.

In one embodiment of the present invention, the groove is a flat and straight groove, and the base is a flat and straight rib complementary to the flat and straight groove.

In one embodiment of the present invention, the bottom wall further comprises two slide channels, and the base has at least two pulleys respectively corresponding to each of the slide channels.

In one embodiment of the present invention, a length of the bottom wall is identical to that of the base.

In one embodiment of the present invention, a length of the bottom wall is greater than that of the base.

In one embodiment of the present invention, the groove is a dovetail-shaped groove and the base is a wedge-shaped rib complementary to the dovetail-shaped groove.

In one embodiment of the present invention, the base is loosely fitted with and accommodated inside the groove.

In comparison with the conventional technologies, the fixed base of the curved television of the present invention achieves the effect of changing the position of the curve television according to the user's requirement by using the groove formed from the bottom wall and the two side walls to accommodate the base of the curved television, so as to solve the problems that the user's viewing positions and viewing angles are limited by the existing curved television, and the using convenience of moving and adjusting the curved television is not improved, and so on.

To make the above description of the present invention more clearly comprehensible, it is described in detail below in examples of preferred embodiments with the accompanying drawings.

### DESCRIPTION OF THE DRAWINGS

FIG. 1A is a stereoscopic schematic view of a fixed base of a curved television of an embodiment of the present invention.

FIG. 1B is a schematic view of a lower portion of a fixed base of a curved television of an embodiment of the present invention.

FIG. 2A is a stereoscopic schematic view of a fixed base of a curved television of another embodiment of the present invention.

FIG. 2B is a schematic view of a lower portion of a fixed base of a curved television of another embodiment of the present invention.

### DETAILED DESCRIPTION OF THE PREFERRED EMBODIMENTS

The following description of the embodiments with reference to the appended drawings is used for illustrating specific embodiments which may be used for carrying out the present invention. Furthermore, the directional terms described by the present invention, such as upper, lower, top, bottom, front, back, left, right, inner, outer, side, around, center, horizontal, lateral, vertical, longitudinal, axial, radial, uppermost or lowermost, etc., are only directions by referring to the accompanying drawings. Thus, the used directional terms are used to describe and understand the present invention, but the present invention is not limited thereto.

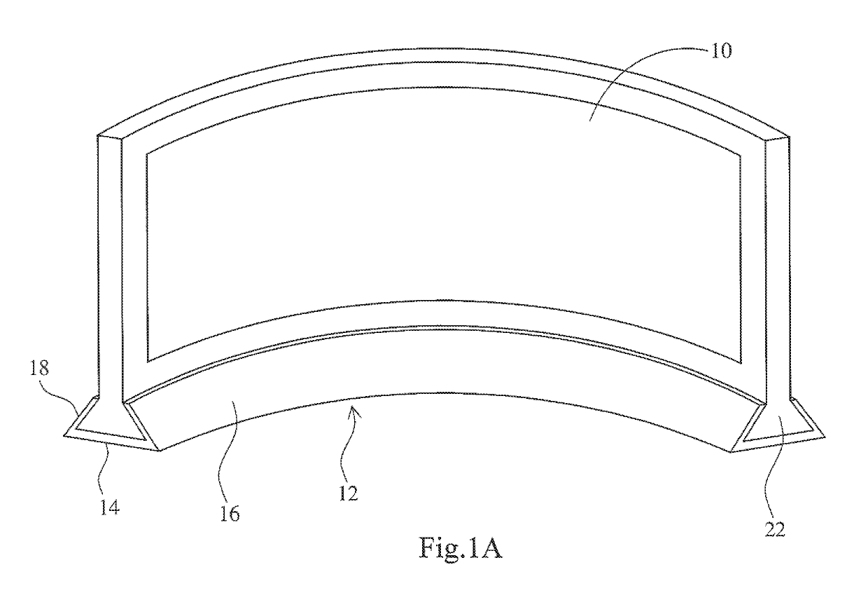

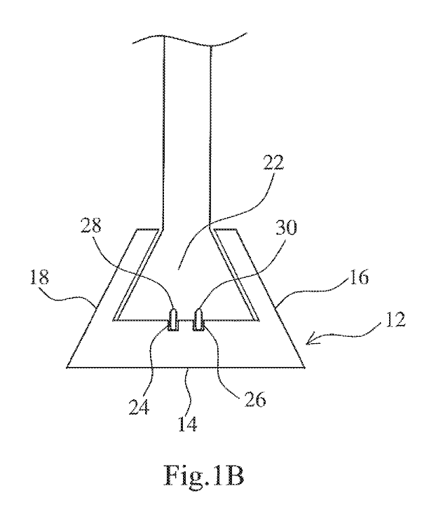

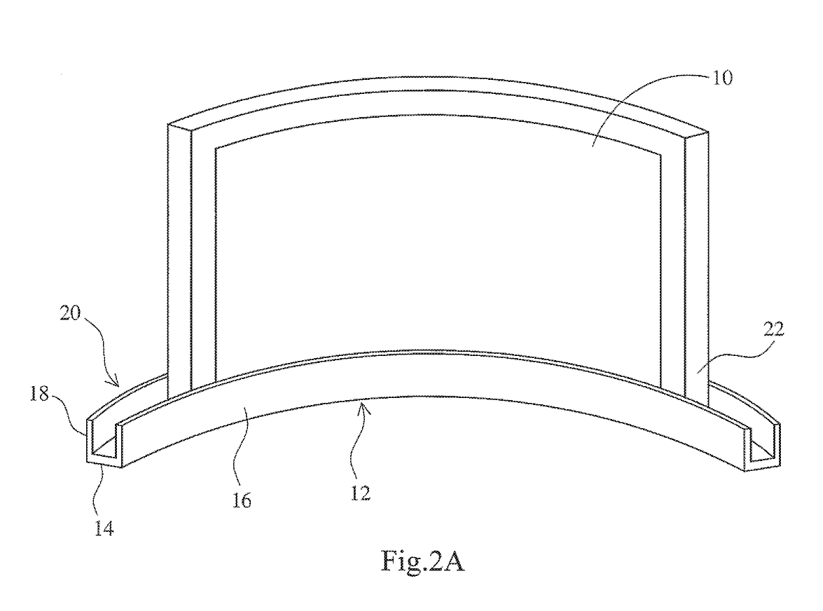

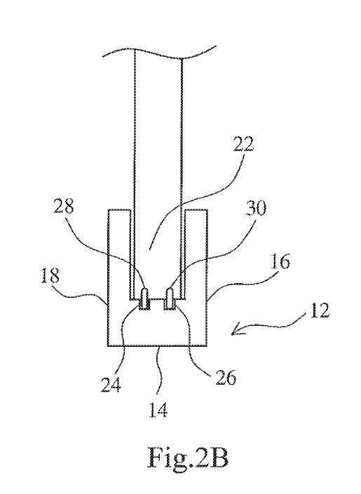

Please refer to FIGS. 1A to 2B. FIG. 1A is a stereoscopic schematic view of a fixed base 12 of a curved television 10 of an embodiment of the present invention; FIG. 1B is a schematic view of a lower portion of a fixed base 12 of a curved television 10 of an embodiment of the present invention; FIG. 2A is a stereoscopic schematic view of a fixed base 12 of a curved television 10 of another embodiment of the present invention; and FIG. 2B is a schematic view of a lower portion of a fixed base 12 of a curved television 10 of another embodiment of the present invention, wherein two slide channels 24 and 26 and at least two pulleys 28 and 30 are not shown in FIGS. 1A and 2A for the conciseness of the drawings. The fixed base 12 is used for movably fixing the curved television 10 to allow the curved television keeping a standing status. The curved television 10 has a liquid crystal panel and relating mechanisms thereof (such as a backlight module, a housing and so on), and further has a base 22. The fixed base 12 includes a bottom wall 14 and two side walls 16 and 18. The bottom wall 14 has a curvature identical to that of a curved television 10. The curvature means a bending curvature of the liquid crystal panel of the curved television 10 while viewing the curved television 10 using as a top-view angle, and the bending curvature of the fixed base 12 is approximately identical to the curvature of the liquid crystal panel. The two side walls 16 and 18 are extended upward from two opposite sides of the bottom wall 14 respectively, wherein the two side walls 16 and 18 and the bottom wall 14 commonly define a groove 20 so as to movably accommodate a base 22 of the curved television 10. In one embodiment, the curved television 10 is movably disposed inside the groove 20 by the base, thereby adjusting the position of the curved television 10.

In one embodiment, please refer to FIGS. 1A and 1B, a length of the bottom wall 14 of the fixed base 12 is identical to that of the base 22 of the curved television 10. In other words, when the base 22 of the curved television 10 is entirely and exactly accommodated inside the groove 20, the aesthetics are improved and the using space is reduced. In another embodiment, please refer to FIGS. 2A and 2B, a length of the bottom wall 14 is greater than that of the base 22, such that the curved television 10 has a greater moving range. However, regardless of if the length of the base wall 14 is equal to or greater than that of the base 22, when it is necessary, a left end (or a right end) of the base 22 of the curved television 10 can selectively protrude out of a left end (or a right end) of the bottom wall 14 of the fixed base 12, so as to enlarge the adjustment of a placing position and a viewing angle of the curved television 10 relative to the user.

In one embodiment, please refer to FIGS. 1A and 1B, the groove 20 is a flat and straight groove, and the base 22 is a flat and straight rib complementary to the flat and straight groove. Because the base 22 can be inserted from the above of the groove 20 or the two side openings, the advantage is to easily dispose the base 22 inside the groove 20. In another embodiment, please refer to FIGS. 2A and 2B, the groove 20 is a dovetail-shaped groove, and the base 22 is a wedge-shaped rib complementary to the dovetail-shaped groove. Because the base 22 can only be inserted from the two side openings of the groove 20, the curved television 10 cannot easily escape from the groove 20, thereby having a better fixing effect.

In one embodiment, please refer to FIGS. 1B and 2B, the bottom wall 14 further comprises two slide channels 24 and 26, and the base 22 has at least two pulleys 28 and 30 respectively corresponding to each of the slide channels 22. The at least two pulleys 28 and 30 are sliding and disposed on the two slide channels 24 and 26, so as to improve the moving ability of the base 22 in the groove 20. In another embodiment, the base is loosely fitted with and accommodated inside the groove 20 for improving the moving ability of the base 22 in the groove 20.

In one embodiment, regardless of the dimensions of the curved televisions, such as curved televisions of 55 inches or below, as long as the curvature of the curved television 10 is identical or similar to that of the bottom wall 14, the curved television 10 can use the fixed base 12 of embodiments of the present invention to achieve the effect of movably fixing, therefore the fixed base 12 of the present invention has a preferred versatility/universality.

As described above, the fixed base of the embodiments of the present invention achieves the effect of changing the position of the curve television according to the user's requirements by using the groove formed from the bottom wall and the two side walls to accommodate the base of the curved television, so as to solve the problems that the user's viewing positions and viewing angles are limited by the existing curved television, and the using convenience of moving and adjusting the curved television is not improved, and so on.

The present invention has been described with preferred embodiments thereof and it is understood that many changes and modifications to the described embodiments can be carried out without departing from the scope and the spirit of the invention that is intended to be limited only by the appended claims.

What is claimed is:

1. A fixed base of a curved television, comprising:
a bottom wall with a curvature identical to that of a curved television; and
two side walls extended upward from two opposite sides of the bottom wall respectively, wherein the two side walls and the bottom wall commonly define a groove so as to movably accommodate a base of the curved television,
wherein the bottom wall further comprises two slide channels, and the base has at least two pulleys respectively corresponding to each of the slide channels; and
wherein the base is loosely fitted with and accommodated inside the groove.

2. The fixed base according to claim 1, wherein a length of the bottom wall is identical to that of the base.

3. The fixed base according to claim 1, wherein a length of the bottom wall is greater than that of the base.

4. The fixed base according to claim 1, wherein the groove is a flat and straight groove, and the base is a flat and straight rib complementary to the flat and straight groove.

5. The fixed base according to claim 1, wherein the groove is a dovetail-shaped groove, and the base is a wedge-shaped rib complementary to the dovetail-shaped groove.

6. A fixed base of a curved television, comprising:
a bottom wall with a curvature identical to that of a curved television; and
two side walls extended upward from two opposite sides of the bottom wall respectively, wherein the two side walls and the bottom wall commonly define a groove so as to movably accommodate a base of the curved television.

7. The fixed base according to claim 6, wherein a length of the bottom wall is identical to that of the base.

8. The fixed base according to claim 6, wherein a length of the bottom wall is greater than that of the base.

9. The fixed base according to claim 6, wherein the groove is a flat and straight groove and the base is a flat and straight rib complementary to the flat and straight groove.

10. The fixed base according to claim 6, wherein the groove is a dovetail-shaped groove, and the base is a wedge-shaped rib complementary to the dovetail-shaped groove.

11. The fixed base according to claim 6, wherein the bottom wall further comprises two slide channels, and the base has at least two pulleys respectively corresponding to each of the slide channels.

12. The fixed base according to claim 6, wherein the base is loosely fitted with and accommodated inside the groove.

13. A curved television, comprising:
a base; and
a fixed base, having:
a bottom wall with a curvature identical to that of the curved television; and
two side walls extended upward from two opposite sides of the bottom wall respectively, wherein the two side walls and the bottom wall commonly define a groove so as to movably accommodate the base of the curved television.

14. The curved television according to claim 13, wherein the groove is a flat and straight groove, and the base is a flat and straight rib complementary to the flat and straight groove.

15. The curved television according to claim 13, wherein the bottom wall further comprises two slide channels, and the base has at least two pulleys respectively corresponding to each of the slide channels.

16. The curved television according to claim 13, wherein a length of the bottom wall is identical to that of the base.

17. The curved television according to claim 13, wherein a length of the bottom wall is greater than that of the base.

18. The curved television according to claim 13, wherein the groove is a dovetail-shaped groove and the base is a wedge-shaped rib complementary to the dovetail-shaped groove.

19. The curved television according to claim 13, wherein the base is loosely fitted with and accommodated inside the groove.
